(19) United States
(12) Patent Application Publication
(10) Pub. No.: US 2024/0300447 A1
(43) Pub. Date: Sep. 12, 2024

(54) SENSOR CLEANING SYSTEM

(71) Applicants: HYUNDAI MOTOR COMPANY, Seoul (KR); KIA CORPORATION, Seoul (KR)

(72) Inventors: Sang Heon Wang, Hwaseong-si (KR); Kyung Hwan Kim, Seoul (KR); Dong Eun Cha, Hwaseong-si (KR); Nak Kyoung Kong, Seongnam-si (KR)

(73) Assignees: HYUNDAI MOTOR COMPANY, Seoul (KR); KIA CORPORATION, Seoul (KR)

(21) Appl. No.: 18/375,012

(22) Filed: Sep. 29, 2023

(30) Foreign Application Priority Data
Mar. 9, 2023 (KR) 10-2023-0031179

(51) Int. Cl. B60S 1/04; B60S 1/52; B60S 1/56

(52) U.S. Cl. CPC B60S 1/0411; B60S 1/522; B60S 1/56

(57) ABSTRACT

A sensor cleaning system includes: a sensor unit configured to monitor an external environment of a vehicle; a cover lens configured to cover a measurement region of the sensor unit; an outer cleaner configured to selectively come in contact with the cover lens; and a transmission unit configured to transmit a driving force of a driving unit to the outer cleaner. The sensor cleaning system also includes a control unit configured to adjust a position of the outer cleaner such that the outer cleaner selectively comes in contact with the cover lens by the driving force of the driving unit, and to move the cover lens up and down.

### CROSS-REFERENCE TO RELATED APPLICATION

The present application claims priority to Korean Patent Application No. KR 10-2023-0031179, filed Mar. 9, 2023, the entire contents of which are incorporated herein for all purposes by reference.

### BACKGROUND

### Technical Field

The present disclosure relates to a sensor cleaning system. More particularly, the present disclosure relates to a sensor cleaning system that includes a cover lens able to be continuously cleaned.

### Description of the Related Art

In general, cameras or lenses that are used for sensor units mounted on vehicles are installed at the same positions for a long period of time, take images of the surrounding environment.

However, the lenses of sensor units may be easily contaminated by the surrounding environment (e.g., dust), leading to a deterioration in the clarity of captured images. Further, when a sensor unit is an essential component for the autonomous driving of a vehicle, severe problems arise in the vehicle's driving performance due to deterioration of accuracy in sensing.

Due to these problems, sensors units, and the like are generally mounted in a casing and a protective glass is mounted over such sensor units. Thus, contamination of the lens of the sensor units is prevented.

However, when a sensor unit is mounted in a casing, it is possible to avoid contamination of the sensor unit, but a protective lens or a lens that is still exposed to the outside is unavoidably contaminated by the external environment. Accordingly, the clearness of an image that is taken is easily deteriorated due to the contamination of the protective glass even though contamination of the sensor unit is prevented. This problem does not align with the technological trend that increasingly demands clearer images.

Accordingly, it is required to continuously clean the exposed side of a sensor unit in order to improve the sensing environment for sensor units that are necessarily used in driving of a vehicle.

### SUMMARY

The present disclosure has been made in an effort to solve the above mentioned problems. An objective of the present disclosure is to provide a sensor cleaning system for removing contamination from a cover lens that protects the outer surface of a sensor unit.

Another objective of the present disclosure is to provide a sensor cleaning system for preventing deterioration of the performance of a sensor unit by cleaning the outside and inside of a cover lens.

The objectives of the present disclosure are not limited to those described above. Other objectives not stated herein may be understood through the following description and may be clear by embodiments of the present disclosure. Further, the objectives of the present disclosure should be achieved by the configurations described in claims and combinations thereof.

A sensor cleaning system for achieving the objectives of the present disclosure includes the following configuration.

As an embodiment of the present disclosure, the sensor cleaning system includes a sensor unit configured to monitor an external environment of a vehicle, and a cover lens configured to cover a measurement region of the sensor unit. The sensor cleaning system further includes an outer cleaner configured to selectively come in contact with the cover lens, and a transmission unit configured to transmit a driving force of a driving unit to the outer cleaner. The sensor cleaning system also includes a control unit configured to adjust a position of the outer cleaner such that the outer cleaner selectively comes in contact with the cover lens by the driving force of the driving unit, and to move the cover lens up and down.

The sensor cleaning system may further include an upper housing configured to cover at least a portion of an upper surface of the cover lens. The sensor cleaning system may further include a lower housing configured to cover at least a portion of a lower surface of the cover lens and the outer cleaner.

The sensor cleaning system may further include a spring member disposed on the lower housing and configured to apply tension in a direction in which the outer cleaner faces the cover lens.

The sensor cleaning system may further include a nozzle unit disposed on the lower housing and configured to spray a fluid cleanser onto the cover lens facing the outer cleaner.

The control unit may be configured such that the fluid cleanser is sprayed onto an outer surface of the cover lens through the nozzle when the cover lens is inserted inside the lower housing.

The transmission unit may include a first gear configured to rotate integrally with the driving unit. The transmission unit may also include a second gear having a first end that is in contact with the first gear, and being configured to rotate integrally with the cover lens.

The sensor cleaning system may further include guide grooves that are positioned on the second gear and in which ends of the outer cleaner are positioned in accordance with movement of the second gear.

The outer cleaner may include a wiper configured to selectively come in contact with the cover lens. The outer cleaner may also include wiper supports, each having first ends positioned at both ends of the wiper and second ends positioned close to a rotation axis of the guide grooves.

The guide grooves each may include two rotation grooves arranged with different distances from a rotation axis of the second gear, and two adjustment grooves connecting both ends of the two rotation grooves to adjust a distance between the wiper and the cover lens. The ends of the outer cleaner may reciprocate along the two rotation grooves and the two adjustment grooves.

The first gear may include a rod having a second end rotating around a first end thereof being in contact with the second gear, and a slot that is positioned in the rod and in which a protrusion of the driving unit is inserted. When the protrusion rotates along the slot, the second end of the rod may move up and down with respect to the first end of the rod.

The sensor cleaning system may further include an inner cleaner in contact with an inner surface of the cover lens.

The sensor cleaning system may further include covers disposed inside the upper housing and the lower housing to cover an outer surface of the transmission unit.

In another embodiment of the present disclosure, a sensor cleansing system includes a sensor unit configured to monitor an external environment of a vehicle, and a cover lens configured to cover a measurement region of the sensor unit. The sensor cleaning system also includes: an outer cleaner configured to selectively come in contact with the cover lens, and a driving unit having a protrusion biased from a rotation axis, and configured to provide a driving force. The sensor cleaning system also includes a transmission unit coupled to the protrusion to transmit a driving force of the driving unit to the outer cleaner. Additionally, the sensor cleaning system includes a control unit configured to adjust a position of the outer cleaner such that the outer cleaner selectively comes in contact with the cover lens by the driving force of the driving unit, and to move the cover lens up and down.

The sensor cleaning system may further include an upper housing configured to cover at least a portion of an upper surface of the cover lens. The sensor cleaning system may further include a lower housing configured to cover at least a portion of a lower surface of the cover lens and the outer cleaner.

The transmission unit may include a first gear configured to correspond to a rotation of the protrusion. The transmission unit may further include a second gear having a first end that is in contact with the first gear, and being configured to rotate integrally with the cover lens.

The sensor cleaning system may further include guide grooves that are positioned on the second gear and in which ends of the outer cleaner are positioned in accordance with movement of the second gear.

The outer cleaner may include a wiper configured to selectively come in contact with the cover lens. The outer cleaner may also include wiper supports, each having first ends positioned at both ends of the wiper and second ends positioned close to a rotation axis of the guide grooves.

The guide grooves each may include: two rotation grooves disposed with different distances from a rotation axis of the second gear; and two adjustment grooves connecting both ends of the two rotation grooves to adjust a distance between a wiper and the cover lens. The ends of the outer cleaner may reciprocate along the two rotation grooves and the two adjustment grooves.

The first gear may include a rod having a second end rotating around a first end thereof being in contact with the second gear. The first gear may also include a slot that is positioned in the rod and in which the protrusion is inserted. When the protrusion rotates along the slot, the second end of the rod may move up and down with respect to the first end of the rod.

The sensor cleaning system may further include a nozzle unit disposed on the lower housing and configured to spray a fluid cleanser onto the cover lens facing the outer cleaner.

According to the present disclosure, it is possible to achieve the following effects from the configuration, combination, and operation relationship to be described below.

The present disclosure has an effect that it is possible to prevent deterioration of the performance of a sensor unit through the sensor cleaning system that provides an outer cleaner.

Further, the present disclosure has an effect of providing an efficient sensor environment by providing a rotatable cover lens and removing contamination both inside and outside the cover lens.

Further, the present disclosure has an effect that it is possible to protect a sensor unit using a cover leans so that the sensor unit is minimally exposed in a driving environment.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a perspective view of a sensor cleaning system as an embodiment of the present disclosure;

FIG. 2 is a side view of the sensor cleaning system as an embodiment of the present disclosure;

FIG. 3 is a side view showing the configuration of a transmission unit of the sensor cleaning system as an embodiment of the present disclosure;

FIG. 4 shows the configuration of a guide groove of the sensor cleaning system as an embodiment of the present disclosure;

FIG. 5 is an enlarged view of the guide groove of the sensor cleaning system as an embodiment of the present disclosure; and

FIGS. 6A to 6D show the movement relationship of an external cleaner and a cover lens when a wiper support is moved along the guide groove as an embodiment of the present disclosure.

### DETAILED DESCRIPTION

Hereinafter, embodiments of the present disclosure are described in detail with reference to the accompanying drawings. Embodiments of the present disclosure may be modified in various ways and the scope of the present disclosure should not be construed as being limited to the embodiments to be described below. The embodiments are provided to completely explain the present disclosure to those having ordinary skill in the art.

Terms “˜er,” “˜system,” and the like used herein mean the units for processing at least one function or operation and may be implemented by hardware, software, or a combination of hardware and software.

Terms used in the present disclosure are used only in order to describe specific embodiments rather than limiting embodiments. Singular forms are intended to include plural forms unless the context clearly indicates otherwise.

A control unit 500 used in the present disclosure may be composed of a memory that stores data about an algorithm for controlling the operations of various components in a vehicle or a program implementing the algorithm. The control unit 500 may also be composed of a processor that performs the operations using the data stored in a database and/or memory. The memory and the processor each may be implemented as a separate chip. Alternatively, the memory and the processor may be implemented into a single chip. For example, the control unit 500 may include at least one of an Electronic Control Unit (ECU), a Central Processing Unit (CPU), a Micro Processor Unit (MPU), a Micro Controller Unit (MCU), an Application Processor (AP), or another type of processor well known in the art. The control unit 500 may be implemented by a combination of software and hardware that can execute at least one application or program for performing the method according to embodiments of the present disclosure.

The control unit 500, which is an electric control unit (ECU) at an ECU level, may be a device that generally controls several electronic devices that are used in vehicles. For example, the control unit 500 can control all of processors at a processor level and controllers at a controller level. The control unit 500 can create control instructions for controlling controllers in accordance with situations by receiving sensing data from processors, and transmit the control instructions to the controllers. However, the ECU level is described as a higher level than the processor level for the convenience of description in the present disclosure, but one processor of processors at the processor level may operate as an ECU or two processors may operate as an ECU in combination.

When a component, device, element, or the like of the present disclosure is described as having a purpose or performing an operation, function, or the like, the component, device, or element should be considered herein as being “configured to” meet that purpose or perform that operation or function.

Some components are given terms “first,” “second,” and the like for discrimination throughout the specification because they have the same names, but they are not necessarily limited to the order in the following description.

Hereinafter, embodiments are described in detail with reference to accompanying drawings. Furthermore, in the following description of the accompanying drawings, like reference numerals are given to like components and repetitive descriptions are omitted.

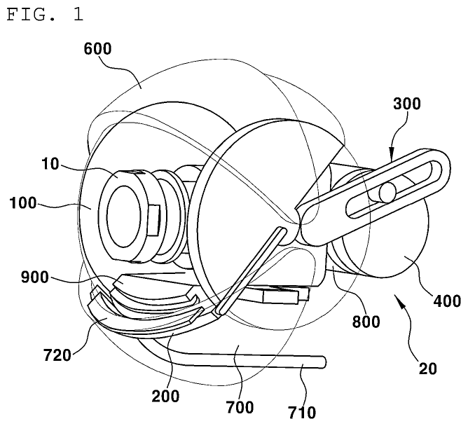

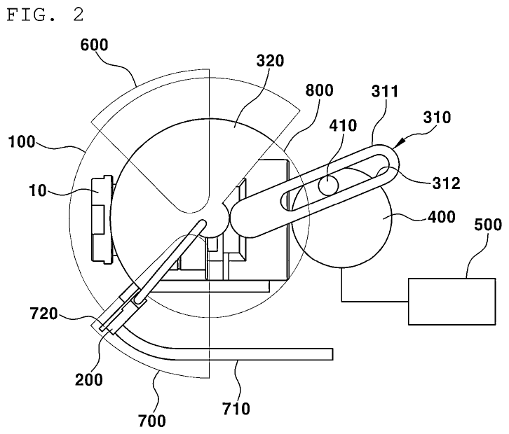

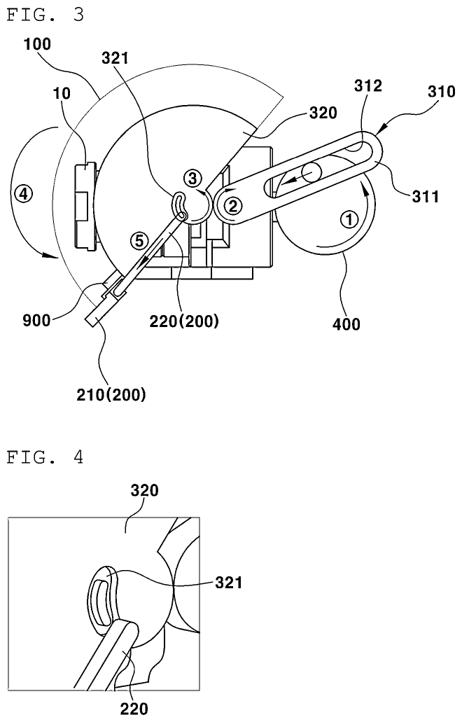

FIGS. 1 and 2 show a sensor cleaning system as an embodiment of the present disclosure. FIG. 3 shows a transmission unit 300 and a driving unit 400 as an embodiment of the present disclosure.

A sensor cleaning system 20 includes a sensor unit 10 configured to be able to monitor an environment outside a vehicle and a cover lens 100 configured to cover at least a portion of the outer surface of the sensor unit 10. The sensor cleaning system 20 further includes an upper housing 600 configured to cover at least a portion of the upper surface of the outer surface of the cover lens 100 and a lower housing 700 configured to cover at least a portion of the lower surface of the outer surface of the cover lens 100. The sensor cleansing system further includes covers 800 disposed at both sides of the cover lens 100, respectively. The covers 800 may be positioned between the cover lens 100 and the upper and lower housings 600 and 700. The covers 800 cover the outer surface of the transmission unit 300.

As an embodiment of the present disclosure, the sensor unit 10 may be at least one of a radar, a light detection and ranging (LIDAR), a camera, an ultrasonic sensor, and a laser sensor that are disposed in a vehicle. More specifically, when the sensor unit 10 is a Lidar or a radar, the upper housing 600 and the lower housing 700 may be configured to include at least one or more openings. The opening is configured to cover at least a portion of the measurement region of the sensor unit 10.

The cover lens 100 is formed in a spherical shape having a predetermined angle in a side cross-section and is configured to be able to rotate up and down with respect to both sides of the sensor unit 10. As an embodiment, the cover lens 100 may be formed in a terrace shape. The cover lens 100 is integrated with a second gear 320 of the transmission unit 300. The cover lens 100 is configured to rotate in the rotational direction of the second gear 320 with respect to the sensor unit 10.

In one form, the transmission unit 300 is coupled to the driving unit 400 and is configured to transmit a torque of the driving unit 400 to the cover lens 100. The transmission unit 300 includes a first gear 310 coupled to the driving unit 400 and a second gear 320 integrated with the cover lens 100. The second gear 320 receives a driving force from the first gear 310. More specifically, the driving unit 400 may have a protrusion 410 inserted in the first gear 310. The protrusion 410 is inserted and positioned in a slot 312 of the first gear 310.

The second gear 320 is coupled to the housing of the sensor unit 10 and is configured to rotate with respect to the sensor unit 10. The first gear 310 has a slot 312 in which the protrusion 410 of the driving unit 400 is inserted. The first gear 310 has a rod 311 configured such that the protrusion 410 longitudinally moves along the slot 312 with the rotation of the driving unit 400. More specifically, the rod 311 of the first gear 310 rotates on a first end coupled to the second gear 320. The first end of the rod 311 is coupled to the housing of the sensor unit 10 to pivot.

In other words, the protrusion 410 of the driving unit 400 is biased from the rotation axis of the driving unit 400, so when the protrusion 410 rotates integrally with the driving unit 400, a second end of the rod 311 of the first gear 310 moves up and down with respect to the first end coupled to the sensor unit 10. The second gear 320 is coupled to the first end of the rod 311 to rotate in correspondence to the up-down rotation of the first gear 310.

The sensor cleaning system 20 includes an inner cleaner 900 fixed to the sensor unit 10. The inner cleaner 900 is in contact with the inner surface of the cover lens 100. The inner cleaner 900 is configured to remove contamination inside the cover lens 100 when the cover lens 100 moves up and down.

An outer cleaner 200 may include a wiper 210 configured to selectively come in contact with the cover lens 100. The outer cleaner 200 may further include wiper supports 220, respectively extending from both ends of the wiper 210 and respectively having ends positioned in guide grooves 321 formed on the sides of the second gear 320. The guide grooves 321 are formed in annular shapes at a predetermined distance from the center axis of the second gear 320. The ends of the wiper supports 220 are positioned in the guide grooves 321 such that the distance between the wiper supports 220 and the center axis of the second gear 320 changes when the guide grooves 321 integrally rotate with the second gear 320. When the wiper supports 220 move along the guide grooves 321, the wiper 210 and the cover lens 100 can selectively maintain a contact state. In other words, the positions where the ends of the wiper supports 220 are fixed in the guide grooves 321 change in correspondence to the rotation of the second gear 320.

The outer cleaner 200 includes a spring member 720 disposed on the lower housing 700 close to the outer cleaner 200. The spring member 720 applies tension in a direction in which the wiper 210 comes in contact with the cover lens 100. Additionally, the spring member 720 applies tension in a direction in which the wiper supports 220 move toward from the center axis of the second gear 320.

Accordingly, the spring member 720 provides predetermined tension so that the contact force between the wiper 210 and the outer surface of the cover lens 100 increases, and simultaneously the wiper supports 220 move along the guide grooves 321.

As an embodiment, when the second gear 320 moves to be inserted inside the lower housing 700, the wiper supports 220 move along the guide grooves 321 such that a gap is formed between the wiper 210 and the cover lens 100. When the cover lens 100 returns after the second gear 320 is inserted inside the lower housing 700, the wiper supports 220 move along the guide grooves 321 such that the wiper 210 comes in contact with the outer surface of the cover lens 100. As a result, the outer cleaner 200 can remove contamination outside the cover lens 100.

Each of the guide grooves 321 has two rotation grooves 321a spaced at predetermined distances apart from the center axis of the second gear 320. When wiper supports 220 are positioned in the rotation grooves 321a, the distance between the wiper 210 and the cover lens 100 is maintained without a change. Adjustment grooves 321b are formed at both ends of the two rotation grooves 321a of each guide groove 321, so when the wiper supports 220 move along the adjustment grooves 321b, the distance between the wiper 210 and the cover lens 100 changes.

In other words, when the wiper supports 220 are positioned in the rotation grooves 321a that is close to the center axis of the second gear 320, the wiper 210 keeps in contact with the cover lens 100. When wiper supports 220 are positioned in the rotation grooves 321a that is far from the center axis of the second gear 320, the wiper 210 and the cover lens 100 keep spaced apart from each other to have a gap.

The sensor cleaning system 20 includes a nozzle unit 710 that is positioned inside the lower housing 700 and is close to the outer cleaner 200. Additionally, the nozzle unit 710 faces the cover lens 100. The nozzle unit 710 is connected to a fluid cleanser reservoir (not illustrated) such that fluid can flow therebetween. The nozzle unit 710 is controlled to spray a fluid cleanser onto the cover lens 100 when the cover lens 100 is inserted inside the lower housing 700.

The control unit 500 is connected to the driving unit 400, the nozzle unit 710, and the sensor unit 10. The controller unit 500 controls the amount of rotation of the driving unit 400 and drives a washer pump to spray a fluid cleanser through the nozzle unit 710. The control unit 500 may be configured to rotate the driving unit 400 based on a sensor cleaning request that is received from the sensor unit 10.

As an embodiment of the present disclosure, the control unit 500 may be configured to analyze an image taken by the sensor unit 10, such as a camera, and determine the degree of contamination in the camera image. The control unit 500 may also be configured to perform sensor cleaning. Alternatively, when the sensor unit 10 is a radar or a Lidar, the control unit 500 may compare measurement intensity or a signal that is received from the sensor unit 10 with a setting value. The control unit 500 may then perform control to clean the sensor unit 10 when the measurement intensity or the signal is under the setting value.

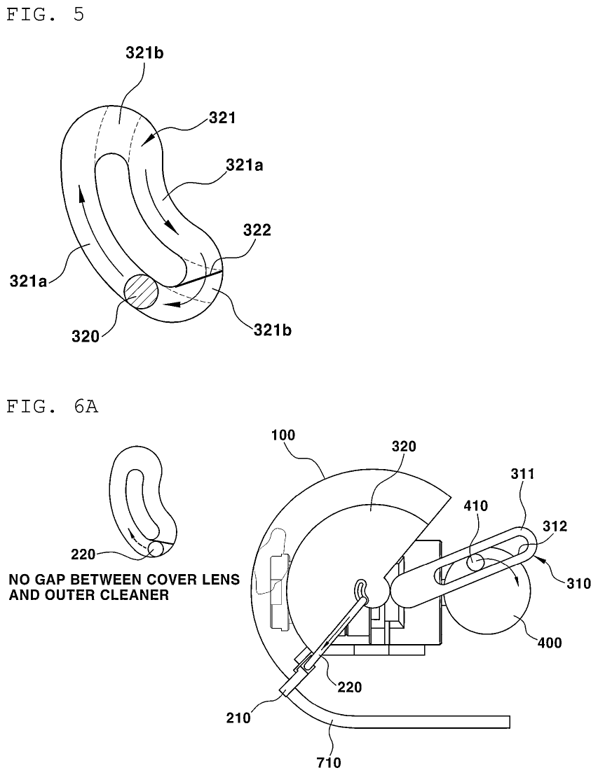

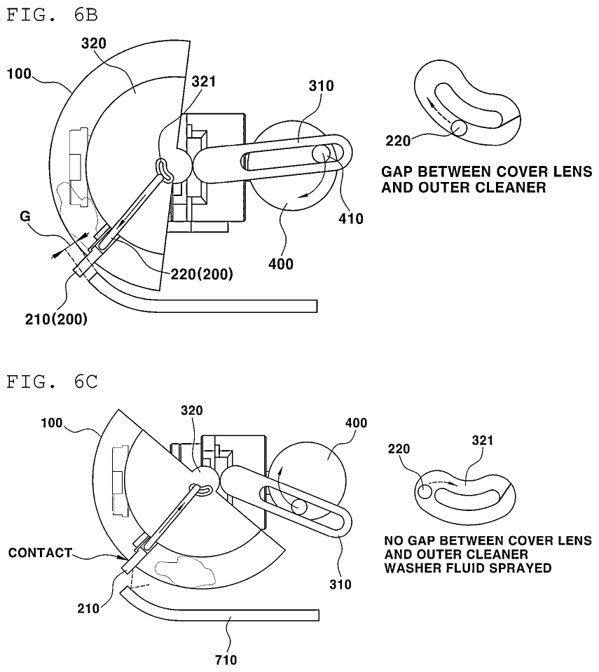

As an embodiment of the present disclosure, FIG. 4 shows the end of a wiper support 220 coupled in a guide groove 321. FIG. 5 shows a path along which the end of a wiper support 220 moves along a guide groove 321.

As shown in the figures, the guide groove 321 is positioned on a side of the second gear 320 and is close to the center axis of the second gear 320. The guide groove 321 is formed in an annular shape having two rotation grooves 321a and two adjustment grooves 321b.

The wiper 210 is fixed close to the lower housing 700, and when the second gear 320 rotates up and down, the cover lens 100 moves up and down integrally with the second gear 320. However, when the second gear 320 moves, the guide grooves 321 are integrally moved in correspondence to the movement of the second gear 320. Thus, the positions where the ends of the wiper supports 220 are coupled to the guide grooves 321 change.

More specifically, when the ends of the wiper supports 220 are positioned in the rotation grooves 321a, the wiper 210 maintains a predetermined gap from the cover lens 100. When the ends of the wiper supports 220 move along the adjustment grooves 321b, the gap between the wiper 210 and the cover lens 100 changes.

In other words, when the wiper supports 220 are positioned in the rotation grooves 321a that are far from the rotation center axis of the second gear 320, the wiper 210 and the cover lens 100 maintain a spaced state with a predetermined gap. When the wiper supports 220 are positioned in the rotation grooves 321a that are far from the rotation center axis of the second gear 320, the cover lens 100 can be inserted inside the lower housing 700 in correspondence to the downward rotation of the second gear 320.

On the contrary, when the ends of the wiper supports 220 are positioned in the rotation grooves 321a that are close to the rotation center axis of the second gear 320 by moving along the adjustment grooves 321b, the wiper 210 comes in contact with the cover lens 100. The cover lens 100 is then inserted inside the lower housing 700 and is moved toward the upper housing 600. In this case, the second gear 320 rotates upward with the wiper 210 in contact with the cover lens 100, whereby contamination outside the cover lens 100 is removed.

In FIG. 5, a guide groove 321 of the guide grooves is depicted. The guide groove 321 has two rotation grooves 321a and adjustment grooves 321b connecting both ends of the rotation grooves 321a. An elastic member 322 is disposed in the adjustment groove 321b.

The elastic member 322 is disposed at a position where the end of the wiper support 220 moves into the rotation groove 321a that is far apart from the center axis of the second gear 320 such that the wiper 210 is spaced apart from the cover lens 100. This is for preventing the phenomenon which occurs when the ends of the wiper supports 220 are not moved along the guide grooves 321 by the spring member 720 that is disposed on the lower housing 700 and should be providing tension to the wiper 210 and the wiper supports 220 toward the rotation center axis of the second gear 320. In other words, the elastic members 322 of each respective guide groove 321, are opened in one direction to allow the ends of the wiper supports 220 to move into the rotation grooves 321a that are far from the center axis of the second gear 320 from the adjustment grooves 321b. Additionally, the elastic members 322 are provided to elasticity prevent the ends from moving in the opposite direction. Accordingly, the elastic members 322 can provide predetermined elasticity such that the ends of the wiper supports 220 can reciprocate along the guide grooves 321 in correspondence to the movement of the second gear 320.

As an embodiment of the present disclosure, the elastic member 322 has a first end coupled in a hinge type to the rotation groove 321a at the outermost side of the guide groove 321. Additionally, the elastic member 322 has a second end close to the adjustment groove 321b to open in one direction. More specifically, the elastic member 322 of the present disclosure may be positioned diagonally to the adjustment groove 321b in the direction in which the end of the wiper support 220 moves.

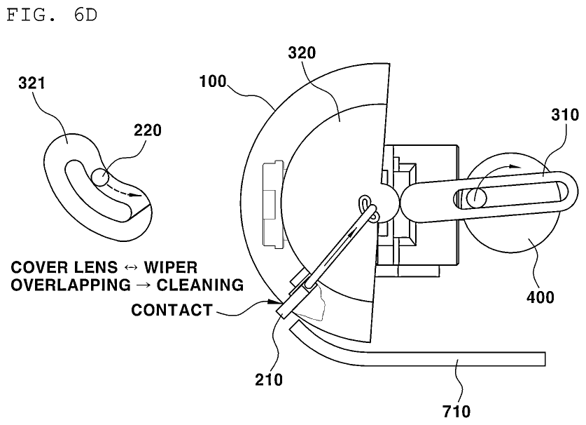

FIGS. 6A-6D show a position relationship of the guide groove 321, in which the end of the wiper support 220 is positioned, according to the rotation of the second gear 320, corresponding to the movement of the cover lens 100.

FIG. 6A shows the case in which the control unit 500 has requested sensor cleaning based on the data measured by the sensor unit 10.

Initially, the end of the wiper support 220 is positioned in the adjustment groove 321b that is close to the elastic member 322. Further, the cover lens 100 is inserted inside the upper housing 600 such that the wiper 210 faces the lower end of the cover lens 100.

Further, the protrusion 410 of the driving unit 400 is positioned at the middle of the slot 312. The second end of the first gear 310 is positioned higher than the first end.

Thereafter, as shown in FIG. 6B, the driving unit 400 rotates clockwise and the protrusion 410 moves to an end of the slot 312 that is close to the end of the rod 311. Further, the second end of the rod 311 of the first gear 310 moves down and the second gear 320 rotates counterclockwise, such that the cover lens 100 rotates down and comes out of the upper housing 600.

Further, the end of the wiper support 220 moves along the rotation groove 321a that is positioned far away from the center axis of the second gear 320. As a result, the wiper 210 of the outer cleaner 200 and the cover lens 100 remain spaced apart, maintaining a gap between them.

FIG. 6C shows the point in time at which the end of the wiper support 220 moves into the rotation groove 321a that is close to the center axis of the second gear 320 along the adjustment groove 321b.

As shown in the FIG. 6C, the protrusion 410 of the driving unit 400 moves along the slot 312, causing the end of the rod 311 to reach its lowermost position. More specifically, the protrusion 410 moves to the middle area of the slot 312. In this case, the second gear 320 maximally rotates down integrally with the cover lens 100.

Further, as the end of the wiper support 220 moves into the rotation groove 321a, which is close to the center axis of the second gear 320, along the adjustment groove 321b, the wiper 210 comes into contact with the cover lens 100. When the wiper 210 comes in contact with the cover lens 100, the control unit 500 drives the washer pump such that a fluid cleanser is sprayed onto the outer surface of the cover lens 100 from the nozzle unit 710. More specifically, the control unit 500 controls the nozzle unit 710 such that a fluid cleanser is sprayed onto the outer surface of the cover lens 100 inserted inside the lower housing 700 across the wiper 210. The outside region of the cover lens 100 to which the fluid cleanser is sprayed includes the region for measuring the external environment through the sensor unit 10.

Thereafter, as shown in FIG. 6D, the end of the wiper support 220 moves into the rotation groove 321a that is close to the rotation center axis of the second gear 320.

The protrusion 410 of the driving unit 400 moves closest to an end of the slot 312 and the second gear 320 coupled to the first end of the rod 311 rotates upward integrally with the cover lens 100.

As depicted in FIG. 6D, the wiper 210 and the cover lens 100 are in contact with each other and the cover lens 100 with the fluid cleanser sprayed thereof rotates up. As a result, the fluid cleanser sprayed onto the upper surface of the cover lens 100 is removed by the wiper 210. Accordingly, the contaminants on the outer surface of the cover lens 100 are removed. Further, the wiper support 220 moves to a position where the elastic member 322 is disposed in the guide groove 321.

The specification provides examples of the present disclosure. Further, the description provides embodiments of the present disclosure and the present disclosure may be used in other various combination, changes, and environments. In other words, the present disclosure may be changed or modified within the scope of the present disclosure described herein, a range equivalent to the description, and/or within the knowledge or technology in the related art. The embodiments show a desired state for achieving the spirit of the present disclosure. The embodiments may be changed in various ways for the detailed application fields and use of the present disclosure. Therefore, the detailed description of the present disclosure is not intended to limit the present disclosure in the embodiments. Further, the claims should be construed as including other embodiments.

What is claimed is:

1. A sensor cleaning system comprising:
a sensor unit configured to monitor an external environment of a vehicle;
a cover lens configured to cover a measurement region of the sensor unit;
an outer cleaner configured to selectively come in contact with the cover lens;
a transmission unit configured to transmit a driving force of a driving unit to the outer cleaner; and
a control unit configured to adjust a position of the outer cleaner such that the outer cleaner selectively comes in contact with the cover lens by the driving force of the driving unit, and to move the cover lens up and down.

2. The sensor cleaning system of claim 1, further comprising:
an upper housing configured to cover at least a portion of an upper surface of the cover lens; and
a lower housing configured to cover at least a portion of a lower surface of the cover lens and the outer cleaner.

3. The sensor cleaning system of claim 2, further comprising a spring member disposed on the lower housing and configured to apply tension in a direction in which the outer cleaner faces the cover lens.

4. The sensor cleaning system of claim 2, further comprising a nozzle unit disposed on the lower housing and configured to spray a fluid cleanser onto the cover lens facing the outer cleaner.

5. The sensor cleaning system of claim 4, wherein the control unit is configured such that the fluid cleanser is sprayed onto an outer surface of the cover lens through the nozzle when the cover lens is inserted inside the lower housing.

6. The sensor cleaning system of claim 1, wherein the transmission unit includes:
a first gear configured to rotate integrally with the driving unit; and
a second gear having a first end that is in contact with the first gear, and being configured to rotate integrally with the cover lens.

7. The sensor cleaning system of claim 6, further comprising guide grooves that are positioned on the second gear and in which ends of the outer cleaner are positioned in accordance with movement of the second gear.

8. The sensor cleaning system of claim 7, wherein the outer cleaner includes:
a wiper configured to selectively come in contact with the cover lens; and
wiper supports, each having first ends positioned at both ends of the wiper and second ends positioned close to a rotation axis of the guide grooves.

9. The sensor cleaning system of claim 7, wherein the guide grooves each include:
two rotation grooves arranged with different distances from a rotation axis of the second gear; and
two adjustment grooves connecting both ends of the two rotation grooves to adjust a distance between a wiper and the cover lens,
wherein the ends of the outer cleaner reciprocate along the two rotation grooves and the two adjustment grooves.

10. The sensor cleaning system of claim 6, wherein the first gear includes:
a rod having a second end rotating around a first end thereof being in contact with the second gear; and
a slot that is positioned in the rod and in which a protrusion of the driving unit is inserted,
wherein when the protrusion rotates along the slot, the second end of the rod moves up and down with respect to the first end of the rod.

11. The sensor cleaning system of claim 1, further comprising an inner cleaner in contact with an inner surface of the cover lens.

12. The sensor cleaning system of claim 2, further comprising covers disposed inside the upper housing and the lower housing to cover an outer surface of the transmission unit.

13. A sensor cleaning system comprising:
a sensor unit configured to monitor an external environment of a vehicle;
a cover lens configured to cover a measurement region of the sensor unit;
an outer cleaner configured to selectively come in contact with the cover lens;
a driving unit having a protrusion biased from a rotation axis, and configured to provide a driving force;
a transmission unit coupled to the protrusion to transmit the driving force of the driving unit to the outer cleaner; and
a control unit configured to adjust a position of the outer cleaner such that the outer cleaner selectively comes in contact with the cover lens by the driving force of the driving unit, and to move the cover lens up and down.

14. The sensor cleaning system of claim 13, further comprising:
an upper housing configured to cover at least a portion of an upper surface of the cover lens; and
a lower housing configured to cover at least a portion of a lower surface of the cover lens and the outer cleaner.

15. The sensor cleaning system of claim 13, wherein the transmission unit includes:
a first gear configured to correspond to a rotation of the protrusion; and
a second gear having a first end that is in contact with the first gear, and being configured to rotate integrally with the cover lens.

16. The sensor cleaning system of claim 15, further comprising guide grooves that are positioned on the second gear and in which ends of the outer cleaner are positioned in accordance with movement of the second gear.

17. The sensor cleaning system of claim 16, wherein the outer cleaner includes:
a wiper configured to selectively come in contact with the cover lens; and
wiper supports, each having first ends positioned at both ends of the wiper and second ends positioned close to a rotation axis of the guide grooves.

18. The sensor cleaning system of claim 16, wherein the guide grooves each include:
two rotation grooves arranged with different distances from a rotation axis of the second gear; and
two adjustment grooves connecting both ends of the two rotation grooves to adjust a distance between a wiper and the cover lens,
wherein the ends of the outer cleaner reciprocate along the two rotation grooves and the two adjustment grooves.

19. The sensor cleaning system of claim 15, wherein the first gear includes:
a rod having a second end rotating around a first end thereof being in contact with the second gear; and
a slot that is positioned in the rod and in which the protrusion is inserted,
wherein when the protrusion rotates along the slot, the second end of the rod moves up and down with respect to the first end of the rod.

20. The sensor cleaning system of claim 14, further comprising a nozzle unit disposed on the lower housing and configured to spray a fluid cleanser onto the cover lens facing the outer cleaner.
